(19) United States
(12) Patent Application Publication
(10) Pub. No.: US 2024/0183661 A1
(43) Pub. Date: Jun. 6, 2024

(54) INTEGRATED PIPE LOCATING AND MARKING SYSTEM

(71) Applicant: The Charles Machine Works, Inc., Perry, OK (US)

(72) Inventor: Scott B. Cole, Edmond, OK (US)

(21) Appl. No.: 18/524,993

(22) Filed: Nov. 30, 2023

Related U.S. Application Data
(60) Provisional application No. 63/429,346, filed on Dec. 1, 2022.

(51) Int. Cl. G01C 15/00; B05C 17/005; G01V 3/17

(52) U.S. Cl. CPC G01C 15/004; B05C 17/00589; G01V 3/17

(57) ABSTRACT

A locating and marking device. The device has one or more antennas capable of detecting a signal emanating from an underground line. A marking device, such as a paint canister, is located on the frame of the device. This marking device leaves a physical or virtual mark at an above-ground path overlying the underground line. A processor receives signals from the antennas and directs the device to place the marking device above the above-ground path. The marking device may move back and forth on a frame of the device, or the device may steer to maintain the marking device in the proper position.

### SUMMARY

The present invention is directed to an apparatus. The apparatus comprises a mobile frame, a first antenna, a second antenna, and a marking device. The mobile frame is defined by a first side and an opposed second side. The first antenna is disposed on the mobile frame proximate the first side. The second antenna is disposed on the mobile frame proximate the second side. The marking device is disposed on the mobile frame between the first antenna and the second antenna.

In another aspect, the invention is directed to an apparatus. The apparatus comprises a mobile frame, a marking device, at least two antennas and a processor. The mobile frame has at least one ground engaging member. The marking device is disposed on the frame. The at least two antennas are configured to detect a signal emanating from an underground line. The at least two antennas are separated by a width. The processor is configured to determine an above-ground path overlying the underground line using the signal and to provide a path signal to the marking device.

The invention is also directed to a system. The system comprises at least one locator, a processor, a mobile frame, and a marking device disposed on the mobile frame. The at least one locator comprises an antenna configured to detect a signal from a below- ground line. The processor is configured to calculate a position of the below-ground line based upon the signal received by the at least one locator. The marking device is in communication with the processor and configured to record a path line on a surface of the ground overlying the below-ground line.

### BRIEF DESCRIPTION OF THE DRAWINGS

FIG. 1 is top left front perspective view of a locating system in accordance with the present invention. The embodiment shown has two tracking devices on a frame with a paint dispenser located on a rail. The paint dispenser is movable along the rail due to a rack and pinion device located thereon.

FIG. 2 is a front view thereof, with a surface of the ground and a subsurface pipe shown. The paint dispenser is disposed directly above the subsurface pipe.

FIG. 3 is a top view thereof, with a path of the subsurface pipe indicated by a dashed line. The direction of travel is at a bottom of the page.

FIG. 4 is a side view of the apparatus. The ground engaging device of FIG. 4 is a wheel, and the apparatus is movable by an operator using a handle. Only one locator is visible in the view of FIG. 4.

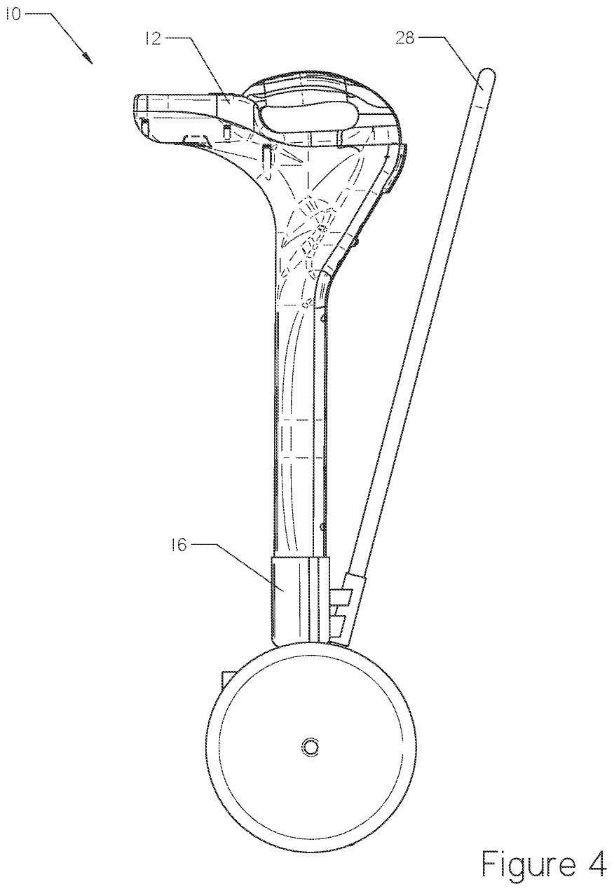

### DETAILED DESCRIPTION

Locate operations for underground utilities are a crucial part of the underground construction process. Utility lines, such as water lines, gas lines, and electrical cables, are hidden under a surface of the ground. Typical locating operations generally involve the placement of a signal on a conductive pipe or wire (here collectively referred to as an “underground line”) at an above-ground access point. The signal is emitted along the below-ground length of the underground line, and that signal can be detected at an above-ground location, as disclosed in U.S. Pat. No. 5,361,029, issued to Rider et al., the contents of which are incorporated herein by reference.

A proper line locate depends highly on the skill and training of the operator. If improperly operated, a line may be incorrectly located before digging. This improper location may cause lines to be destroyed during construction. The above-ground path of the underground line is typically marked by a professional with markers such as flags or paint. Once the paths are marked, an installation or construction operation can begin with the underground lines clearly marked. This invention is intended to reduce or eliminate the opportunity for human error in line locating processes.

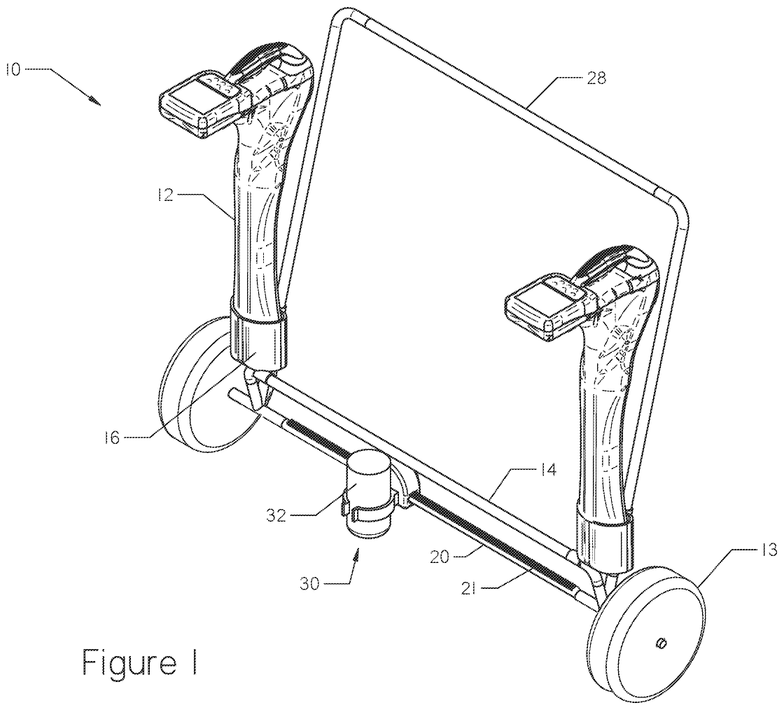

Turning now to the figures, an integrated pipe locating and marking system 10 is shown. The system comprises at least one locator 12 supported on a mobile frame 14. The frame 14 is supported by one or more ground engaging member 13, such as the wheels shown in FIG. 1. Alternatively, tracks may be used as a ground engaging member 13 to support the frame 14. The ground engaging member 13 may rotate freely about an axle (as when an operator pushes or pulls the frame 14) or may be engaged with a motor (not shown) for self-propulsion. The ground engaging member 13 may comprise an encoder or other sensor to precisely determine the movement of the frame 14 across a surface of the ground.

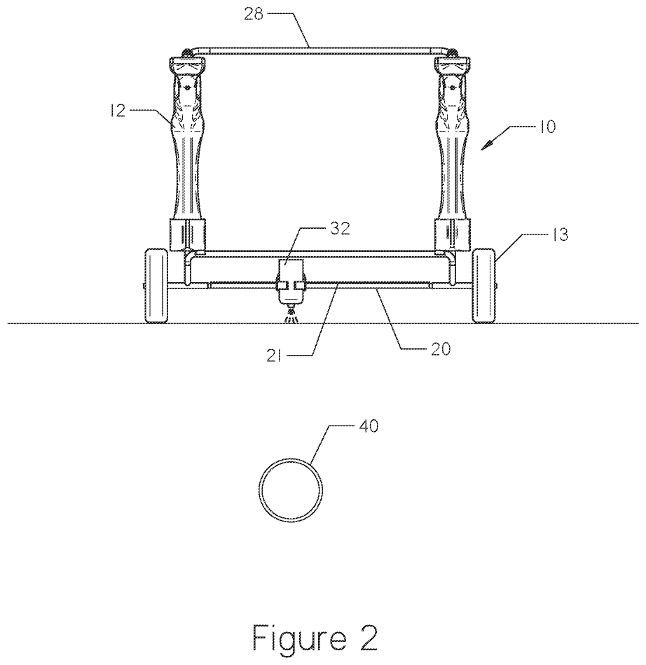

The one or more locators 12 may be integrated into the frame 14, or configured for insertion into a designated mount 16. The locators 12 comprise antenna assemblies configured to receive a signal generated at a below ground line 40 (FIG. 2). Locators 12 have been used to detect a position of an underground line 40 for decades. One such locator is shown in U.S. Pat. No. 5,361,029, issued to Rider, the contents of which are incorporated by reference herein.

Preferably, at least two locators 12 are utilized with the system 10 in order to provide more information about a magnetic field. While two locators 12 may be advantageous, adding spaced-apart additional locators to the frame 14 may increase accuracy of the system 10 by smoothing out errors caused by noise. The frame 14 is preferably wide enough to provide meaningful spacing between the locators 12 while remaining small enough to be applicable to residential projects, and others, where fitting the frame 14 through a gate or other restricted opening is preferred. One likely width of the frame 14 is three feet, though this width does not limit the use of the invention.

The locators 12, as shown, are each disposed on opposing sides of the frame 14, and separated by a rail 20 which extends between the opposing sides of the frame 14. A rack 21 is disposed along a portion of the length of the rail 20. A marking device 30 is disposed on the rail 20. The marking device 30 includes a pinion or gear drive which allows the marking device 30 to translate along the rack 21. As shown, the marking device includes a paint dispenser 32.

Rather than using a rack 21, the marking device 30 may propel itself along a smooth rail 20 (which may have a cylindrical or prism shape to enhance connection between the device 30 and rail 20). Additionally, the marking device 30 may be disposed on a line which is attached to the marking device 30 at each end, wherein the line pulls the marking device towards one of the locators 12 or the other.

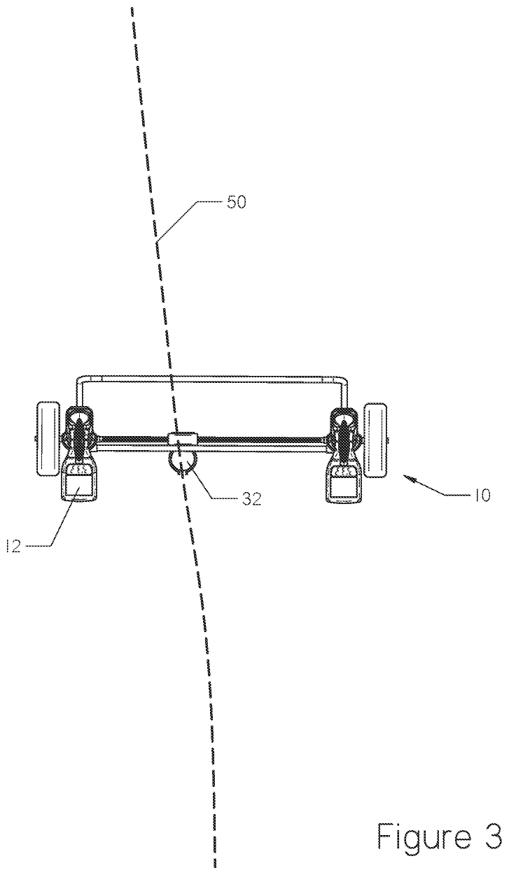

As shown, the locators 12 determine an above-ground path (line 50 on FIG. 3) of the underground line 40. As the frame is moved along the expected above-ground path of the underground line 40, the locators 12 communicate the received signal to a processor, which is configured to triangulate a position of the line 40 and send a signal to the marking device 30. This signal may, for example, instruct the marking device 30 to move along the rail 20 to a position directly over the line 40. The marking device 30 moves left or right along the rail 20 relative to the locators 12. For example, if a rack 21 and pinion system is used, the marking device signal would cause the device 30 to move left as the detected above-ground path 50 of the underground line 40 moves.

Alternatively, the marking device 30 may be located at a static position relative to the locators 12. In this embodiment, the marking device signal could provide an alert to the operator, instructing the shifting of the frame 14 to follow the path 50. In a further alternative embodiment, the marking device signal may be sent to the ground engaging members 13. Individual motors for tracks or wheels would allow the frame 14 to be self-propelled while following the path 50 with the marking device 30 disposed directly above the path. Such a self-propelled frame may be operated by a remote control station or device, or may be automatically controlled using pre-existing parameters and the signal detected by the locators 12.

In a further alternative, the marking device 30 may include nozzles may be disposed along the frame line defined by the rail 20. The processor determines which nozzle is directly above the underground line 40 and directs a system of valves to open or close to correctly mark the path using the nozzle most closely above the path 50 as the frame 14 is translated along its path of travel.

The processor may be located on board the frame 14, such as at one or more of the locators 12, or may alternatively be placed at an off-board system.

The paint dispenser 32, or other marking device, marks the ground surface directly over the underground line 40 at different intervals. These intervals may be manually initiated, automatically initiated, initiated by revolutions of the wheels, etc. The frame 14 may alternatively include a Bluetooth radio which could be used to track a position of the frame and initiate marking. Alternatively, the paint dispenser 32 continuously dispenses paint, resulting in a line similar to line 50.

If the underground line 40 is determined to be outside of the limits of the rack 20, the system no longer marks the ground with paint. Further, if an error, such as a weak or erratic Bluetooth signal occurs, marking may stop until the error condition is corrected.

While physical paint is discussed, the system 10 may be adapted to provide a virtual line for communication to later utility installers. The system 10 may comprise a memory, such that the expected above-ground position of the underground line 40 is stored in the memory as the frame 14 traverses a length of the underground line 40. This technique is referred to as providing “virtual paint” which may be overlayed on a map of a site where excavation is to be conducted. One of skill in the art will appreciate that a virtual marking tool would not, necessarily (but could) traverse the frame 14, but that the locators 12 could detect (and the processor and memory could store) the position of the underground line 40 without the use of a moving marking tool.

Preferably, when a virtual marker is used, a virtual line is stored in the memory in conjunction with the marking of a paint line by the paint dispenser 32, providing both a visual and virtual representation of an above-ground path overlying the underground line 40.

In operation, the legs of the frame 14 would be initially placed near the line to be located, with the rail 20 perpendicular to the expected orientation of the target underground line 40. The frame would then be moved along the underground line 40 (along a path of travel) while the paint dispenser 32 marks its location. The rail 20 extends along a line, herein referred to as a “frame line”, which may extend between the first and second locators 12.

The operator (or processor, if self-propelled) only needs to keep the paint dispenser 32 from reaching a limit of the length of the rail 20. A warning system could be implemented, such as a colored light or an alarm if the line becomes out of range.

Alternatively, the frame 14 may automatically stop and redirect to a location overlying the below-ground line 14 if the line becomes out of range.

The frame has a handle 28 which may be utilized by an operator to propel the system 10 along the ground. Should the frame be self-propelled, it may utilize more than two ground engaging members 13 to maintain stability low to the ground while moving along the line 50 without the need for active human interaction. Four wheels, for example, could be used to maintain a stable base while providing for mobility across varied surfaces.

The frame 14 may be pulled by a motorized system such as a work machine. One motorized system with locators 12 located thereon is shown in U.S. Pat. Pub. No. 2021/0131615,authored by Bailey et. al., the contents of which are incorporated herein by reference. The Bailey reference does not have a processor or a marking apparatus.

The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology to the full extent indicated by the broad general meaning of the terms in which the appended claims are expressed.

1. A system comprising:
at least one locator, the locator comprising an antenna configured to detect a signal from a below-ground line;
a processor configured to calculate a position of the below-ground line based upon the signal received by the at least one locator;
a mobile frame; and
a marking device disposed on the mobile frame, wherein the marking device is in communication with the processor and configured to record a path line on a surface of the ground overlying the below-ground line.

2. The system of claim 1 wherein the at least one locator comprises a first locator and a second locator, wherein the first locator and second locator are disposed on the mobile frame and further comprising:
a rail disposed between the first locator and the second locator;
wherein the marking device is disposed on the rail.

3. The system of claim 2 further comprising:
a motor, in which the marking device is moved along the rail by the motor.

4. The system of claim 3 in which the motor is configured to move the marking device in response to a signal from the processor.

5. The system of claim 3 wherein the frame further comprises a rack disposed on the rail and further comprising:
a pinion coupled to the motor such that operation of the motor rotates the pinion, and wherein the pinion is engaged with the rack.

6. The system of claim 1 in which the mobile frame is self-propelled.

7. The system of claim 1 in which the mobile frame comprises a handle.

8. The system of claim 1 in which the marking device comprises a paint dispenser.

9. The system of claim 8 in which the paint dispenser is configured to dispense paint at intervals along the path line.

10. An apparatus comprising:
a mobile frame having at least one ground engaging member;
a marking device disposed on the frame;
at least two antennas configured to detect a signal emanating from an underground line, wherein two of the at least two antennas are separated by a width;
a processor configured to determine an above-ground path line overlying the underground line using the signal and provide a path signal to the marking device.

11. The apparatus of claim 10 in which the marking device is configured to maintain a position on the mobile frame overlying the above-ground path line in response to the path signal.

12. The apparatus of claim 11 in which:
the at least two antennas are disposed on the mobile frame and separated by the width;
the mobile frame comprises a rail;
the marking device is disposed on the rail; and
the marking device comprises a motor; and
wherein the motor receives the path signal and, in response to the path signal, rotates in a first direction or a second direction to maintain the marking device at a position overlying the above-ground path.

13. The apparatus of claim 11 in which the marking device comprises a paint dispenser.

14. The apparatus of claim 13 in which the above-ground path is stored in a memory.

15. A method of using the apparatus of claim 11 comprising:
placing the mobile frame in an area overlying the underground line;
detecting, with the at least two antennas, a signal emanating from the underground line;
in response to the signal, determining an above-ground path overlying the underground line; and
recording a position of the above-ground path.

16. The method of claim 15 wherein the step of recording a position of the above- ground path comprises marking the above-ground path with paint.

17. The method of claim 15 further comprising the step of recording a position of the above-ground path comprises virtually marking the above-ground path in a data storage.

18. The method of claim 15 further comprising:
in response to the signal, causing the marking device to move along the width of the mobile frame to maintain a position overlying the above-ground path.

19. An apparatus comprising:
a mobile frame, the mobile frame defined by a first side and an opposed second side, the mobile frame configured to be moved along a direction of travel;
a first antenna disposed on the mobile frame proximate the first side;
a second antenna disposed on the mobile frame proximate the second side; and
a marking device disposed on the mobile frame on a frame line between the first antenna and the second antenna, wherein the frame line is orthogonal to the direction of travel; and
wherein the marking system is configured to selectively mark a location along the frame line.

20. The apparatus of claim 19 in which the marking device is movable along the line.

21. A system, comprising:
the apparatus of claim 19; and
a processor;
wherein :
the first antenna sends a first signal to the processor indicative of a position of a below-ground line;
the second antenna sends a first signal to the processor indicative of a position of the below-ground line;
the processor determines an estimated above-ground path overlying the below-ground line using the first signal and the second signal.

22. The system of claim 21 in which the processor generates a marking device signal, whereby the apparatus is configured to place the marking device at a position on the frame line directly above the above-ground path in response to the marking device signal.

23. The system of claim 22 in which the marking device is configured to move along the frame line in response to the marking device signal.

24. The system of claim 22 in which the mobile frame comprises at least one ground-engaging motive member, and wherein:
the rotation of the at least one ground-engaging motive member is directed by the marking device signal.
